(19) United States
(12) Patent Application Publication
(10) Pub. No.: US 2015/0081497 A1
(43) Pub. Date: Mar. 19, 2015

(54) SYSTEM AND METHOD FOR MANAGING A REAL ESTATE AND/OR BUSINESS TRANSACTION PROCESS BETWEEN A BUYER AND A SELLER

(71) Applicants: Tarun Patel, San Jose, CA (US); Khanderao Kand, San Jose, CA (US); Davinder Pal Gulati, San Jose, CA (US); Mukesh J. Mowji, San Jose, CA (US)

(72) Inventors: Tarun Patel, San Jose, CA (US); Khanderao Kand, San Jose, CA (US); Davinder Pal Gulati, San Jose, CA (US); Mukesh J. Mowji, San Jose, CA (US)

(21) Appl. No.: 14/218,550

(22) Filed: Mar. 18, 2014

Related U.S. Application Data
(60) Provisional application No. 61/879,053, filed on Sep. 17, 2013.

(51) Int. Cl. G06Q 50/16; G06Q 40/00

(52) U.S. Cl. CPC G06Q 50/16; G06Q 40/00
USPC 705/35

(57) ABSTRACT

A system for managing a real estate and/or business transaction between a buyer and a seller from receiving information from the seller regarding a commercial property, or other asset, to be sold, to closing, is provided. The system may be configured to generate a valuation of the commercial property and/or asset to be sold for the buyer and/or the seller, to populate and generate documents related to the transaction, to enable the buyer and the seller to accept or reject documents related to the transaction, and to gather relevant documents, invoices, and property data to send to an escrow agency.

### CROSS-REFERENCE TO RELATED APPLICATION

This application claims the benefit of U.S. provisional application Ser. No. 61/879,053, filed on Sep. 17, 2013, and entitled, “System and Method for Managing a Real Estate and/or a Business Transaction between a Buyer and a Seller,” the contents of which are incorporated by reference in its entirety.

### FIELD OF INVENTION

The present invention is directed to a system and method for managing a real estate and/or business transaction process between a buyer and a seller.

### BACKGROUND

Real estate transactions, such as commercial real estate transactions and/or business transactions, can be time-consuming and filled with paperwork and inefficiencies. Often times, physical documents are transferred back and forth between buyers and sellers in an inefficient and confusing manner. Buyers may not be able to accurately determine the value and/or commercial potential of a property, and sellers may not be able to accurately determine the sales price of the property. Additionally, valuation can be inaccurate and a function of the entity actually performing the valuation. Accordingly, a system and method for managing a real estate and/or business transaction between a buyer and a seller is needed.

### SUMMARY OF PREFERRED EMBODIMENTS

A computer-readable program product comprising a non-transitory computer-readable medium is provided. The computer-readable program product may include code for: receiving and processing information from a first seller and a first buyer regarding purchase price and other values related to a first commercial real estate transaction; populating a first offer or first counteroffer document with the information; generating the first offer or first counteroffer document; and providing the first offer or first counteroffer document to the first buyer or the first seller; providing the first seller or the first buyer the option to accept, reject, or counteroffer the first offer or the first counteroffer document; sending notification to the first seller or the first buyer regarding acceptance, rejection, or counteroffer of the first offer or the first counteroffer document; and displaying transaction history between the first buyer and the first seller related to the first commercial real estate transaction. Preferably, the computer-readable program product may include code for retrieving standard industry data from third party sources; and receiving and processing financial information and documents provided by the seller to generate a valuation of a first commercial property. Preferably, the computer program product includes code for displaying transaction history between the first seller and a second buyer related to a second commercial real estate transaction. Preferably, the computer-readable program product includes code for displaying transaction history between the first buyer and a second seller related to a third commercial property transaction. Preferably, the computer program product includes code for populating a second offer or second counteroffer document with the information; generating the second offer or second counteroffer document; and providing the second offer or second counteroffer document to the first buyer or the first seller; and providing the first seller or the first buyer the option to accept, reject, or counteroffer the second offer or the second counteroffer document.

A system for managing a commercial real estate transaction between a buyer and a seller is provided. The system includes a memory; a processing circuit; and a server module stored on the memory. The system is configured to perform the steps of: receiving and processing information from a first seller and a first buyer regarding purchase price and other values related to a first commercial real estate transaction; populating a first offer or first counteroffer document with the information; generating the first offer or first counteroffer document; providing the first offer or first counteroffer document to the first buyer or the first seller; providing the first seller or the first buyer the option to accept, reject, or counteroffer the first offer or the first counteroffer document; sending notification to the first seller or the first buyer regarding acceptance, rejection, or counteroffer of the first offer or the first counteroffer document; and displaying transaction history between the first buyer and the first seller related to the first commercial real estate transaction.

A computer-implemented method for managing a commercial real estate transaction between a buyer and a seller is provided. The computer-implemented method includes the steps of receiving and processing, in a computer or a mobile device, information from a first seller and a first buyer regarding purchase price and other values related to a first commercial real estate transaction; populating, in a computer or a mobile device, a first offer or first counteroffer document with the information; generating, in a computer or a mobile device, the first offer or first counteroffer document; providing, in a computer or a mobile device, the first offer or first counteroffer document to the first buyer or the first seller; providing, in a computer or a mobile device, the first seller or the first buyer the option to accept, reject, or counteroffer the first offer or the first counteroffer document; sending, in a computer or a mobile device, notification to the first seller or the first buyer regarding acceptance, rejection, or counteroffer of the first offer or the first counteroffer document; and displaying, in a computer or a mobile device, transaction history between the first buyer and the first seller related to the first commercial real estate transaction.

### BRIEF DESCRIPTION OF DRAWINGS

The invention may be more readily understood by referring to the accompanying drawings in which:

FIG. 1 is a block diagram of a system and method of the present invention;

FIG. 2 is a block diagram of a computer system that may be used for implementing the system and method of the present invention;

FIG. 3 is a network diagram illustrating a network of computer systems that may be used for implementing the system and method of the present invention;

FIG. 4 is an exemplary flow chart of the system and method of the present invention;

FIG. 5 is an exemplary flow chart of the system and method of the present invention;

FIG. 6 is an exemplary flow chart of the system and method of the present invention;

FIG. 7 is an exemplary flow chart of the system and method of the present invention;

FIG. 8 is an exemplary flow chart of the system and method of the present invention;

FIG. 9 is an exemplary screen shot of the present invention;

FIG. 10 is an exemplary screen shot of the present invention;

FIG. 11 is an exemplary block diagram of a network of the present invention;

FIG. 12 is an exemplary block diagram of a system of the present invention;

FIG. 13 is an exemplary block diagram of a system of the present invention;

FIG. 14 is an exemplary block diagram of a system of the present invention;

FIG. 15 is an exemplary block diagram of a system of the present invention;

FIG. 16 is an a flow chart of an exemplary method of the present invention;

FIG. 17 is an exemplary block diagram of a system of the present invention; and

FIG. 18 is a flow chart of an exemplary method of the present invention.

Like numerals refer to like parts throughout the several views of the drawings.

### DETAILED DESCRIPTIONS OF PREFERRED EMBODIMENTS

### Definitions

“Agency” or “administrator” refers to the individual, business, agency that may provide real estate/business transaction services to a buyer and a seller.

“Buyer” refers to a person or other entity that makes a purchase of a real property or other asset, intends to make a purchase, or is otherwise interested in available real property or other asset. “Buyer” may also refer to an agent and/or broker (a person or other entity such as a company) that assists a buyer with a purchase of a real property or other asset, as well as a developer, manager, and/or any other person or entity that has an interest in one or more properties or assets.

“Closing” refers to the point in time wherein paperwork related to the transaction has been sent to the escrow agency (or other entity) to allow for recording of the real estate and/or business transaction.

“Client” refers to a buyer or a seller as defined herein, or any other user as defined herein.

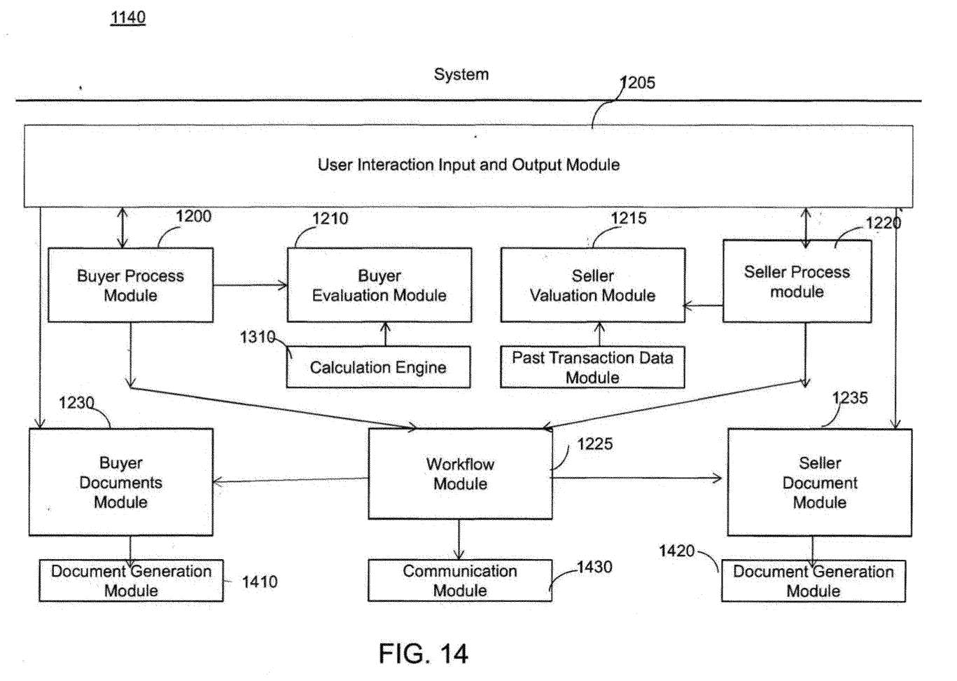

“Client module” may be interchangeable with “client computer.” “Client module” may include one or more of the modules shown in FIG. 14, such as the user interaction input and output module 1205, as well as the what-if scenario calculator shown in FIG. 14.

“Configured to,” means adapted for, employed, implemented, or programmed, as well as any combination thereof, to carry out some process, function, step or routine.

“Computerized electronic server” or “electronic server” may refer to a website, web-enabled software, and/or any other electronic medium. Preferably, the computerized electronic server is encrypted. For example, it may be encrypted using SPAC software, or any other application for file encryption or sharing. It may also refer to a local area network or a cell phone network.

“Method,” or any grammatical version thereof, may be interchangeable with “computer-implemented method.” In other embodiments, however, “method” is not interchangeable with “computer-implemented method.”

Data messages” refer to data or information generated, sent, received or stored by electronic means.

“Electronic device” may refer to a computer (i.e., laptop or desktop), mobile device, personal digital assistant, smart phone, digital television, Internet protocol television, and/or play stations.

“Real estate transaction” refers to the exchange of property (i.e., real property), whether residential or commercial, for money or other consideration. “Commercial real estate transaction” refers to the exchange of commercial property, such as hotels/motels, gas stations, convenience stores, and the like.

“Seller” refers to a person or other entity that sells a real property or other asset, intends to sell a real property or other asset, or has an interest in selling real property or other asset. “Seller” may also refer to an agent and/or broker (a person or other entity such as a company) that assists a seller with selling a real property or other asset, as well as a developer, manager, and/or any other person or entity that has an interest in one or more properties.

“User” refers to any entity, such as a buyer or seller, who/which accesses information through a communication network, including, but not limited to, the Internet.

“Internet website” is interchangeable with “website” and “Internet.” It may also refer to any electronic medium capable of data transmission. “Website” as used herein may refer to the inventive website of the present invention.

In a computer or a mobile device” may refer to “operational in a computer or a mobile device.” It may also refer to any other “in an electronic device,” such as any electronic device now known or later contemplated.

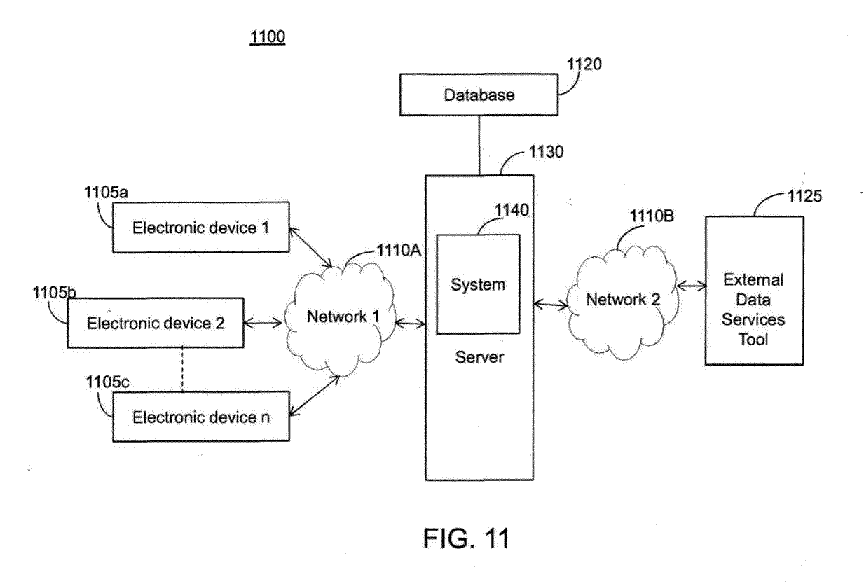

“Server module” is interchangeable with “server.” In some embodiments, “server module” may be interchangeable with “system 1140” of FIG. 11.

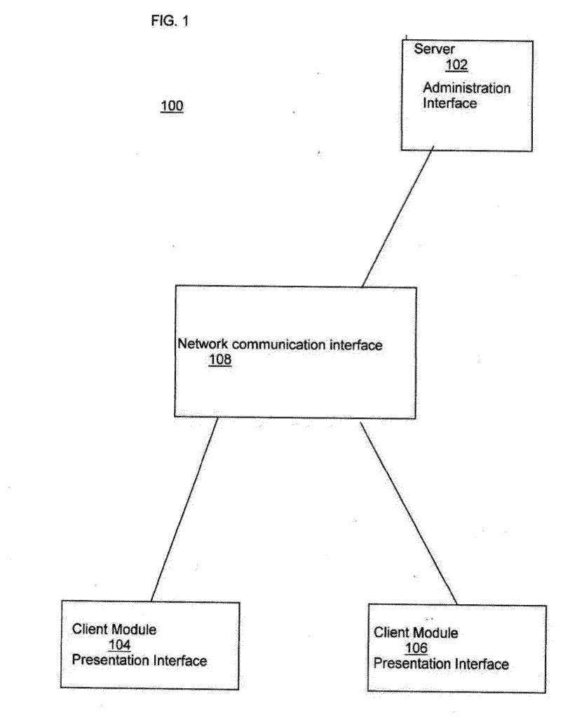

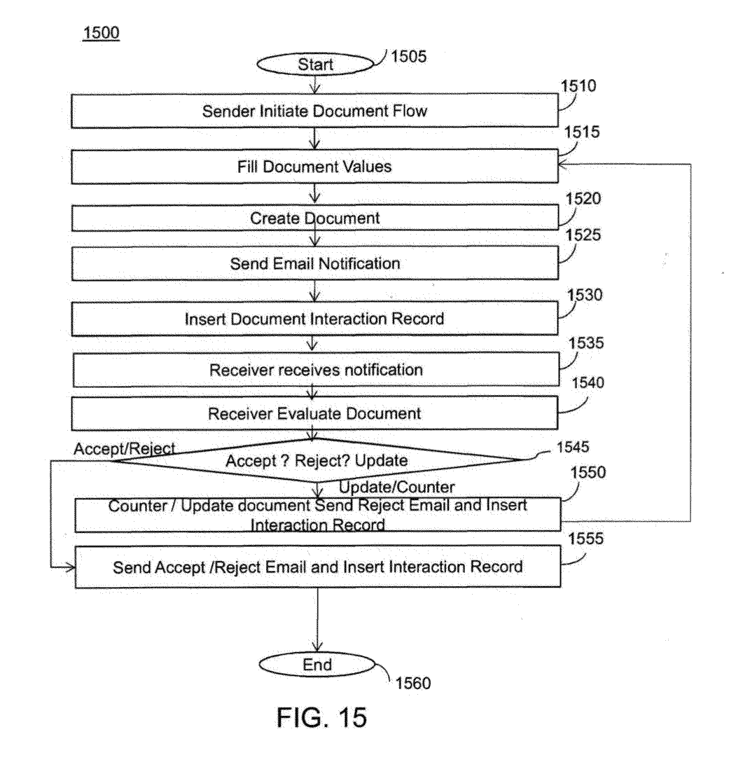

Referring to FIGS. 1-18, the present invention is directed to a system and method for managing a real estate and/or business transaction between a buyer and a seller, preferably a commercial real estate transaction and/or other business transaction. Preferably, the system and method of the present invention is facilitated by the use of a network communications interface (communications network) such as an Internet website, accessible via a device capable of displaying an Internet website such as a computer or processor, a mobile device, any other electronic device, or the like. Preferably, the Internet website displays one or more graphical user interfaces (referred to herein singularly and plurally as “GUI”). As used herein, the GUI may be a user interaction input and output module 1205, as shown in FIG. 14.

A graphical user interface is a type of user interface that allows users to interact with programs in more ways than simply typing. The user is generally able to access the GUI by entering a secure website on the Internet, or any other electronic medium. The GUI may be accessed by any web-enabled device, such as a computer or mobile device. Preferably, the GUI is displayed on an Internet website accessible via a computer.

FIG. 1 is an exemplary block diagram of a system 100 of the present invention. System 100 includes one or more servers 102 (referred to singularly and plurally as “102”). In some embodiments, referring to FIG. 14, system 100 may be referred to herein as system 1140. Server 102 may be a virtual server. The client modules 104 and 106 (it is to be understood that any number of client modules may be used, and two is a representative number) may communicate with server 102 through network communication interface 108, such as the Internet. Server 102 may contain one or more databases. As further described below, in some embodiments, the database may store information in one or more related databases that are logically grouped by predetermined areas. These areas may be, for example, property listings, transaction records, valuation records, and the like. As used herein, “database” should be understood to cover reference to a single database or a collection of databases. The database may be on virtual server 102. For example, the database may be on the cloud (wherein a network of remote servers is hosted on the Internet to store, manage, and process data, rather than a local server). In other embodiments, information may be stored or arranged using a variety of data storage software and hardware techniques known to those of ordinary skill in the art of database programming. For example, one database system that may be used with the present invention is the SQL Server system as offered by Microsoft Corp. Other data storage systems, such as those based on Oracle Database products offered by Oracle Corporation or the MySQL database server offered by MySQL AB, may be used. These data storage systems run on a variety of hardware platforms, including those based on the microprocessors offered by Advanced Micro Devices2, Inc., or Intel Corp. In addition, the system may include a software system.

FIG. 11 is an exemplary block diagram of a network 1100 of the present invention. Network 1100 preferably includes a system 1140. System 1140 may include one or more electronic devices (identified herein as 1105a, 1105b, and 1105c), network 1110a, network 1110b, database 1120, server 1130, system 1140 and/or an external data services tool 1125. Exemplary networks 1110a (or network 108 as shown in FIG. 1) include, but are not limited to, Internet, Ethernet, local area network, wireless, wide area network, metropolitan area network, and small area network. A client, such as a buyer and/or a seller, may interact with system 1140 via network 1110a. Preferably, system 1140 is configured to receive inputs from client and provide outputs from system 1140 to client. For example, the client may be provided with a GUI in order for the client to interact with it.

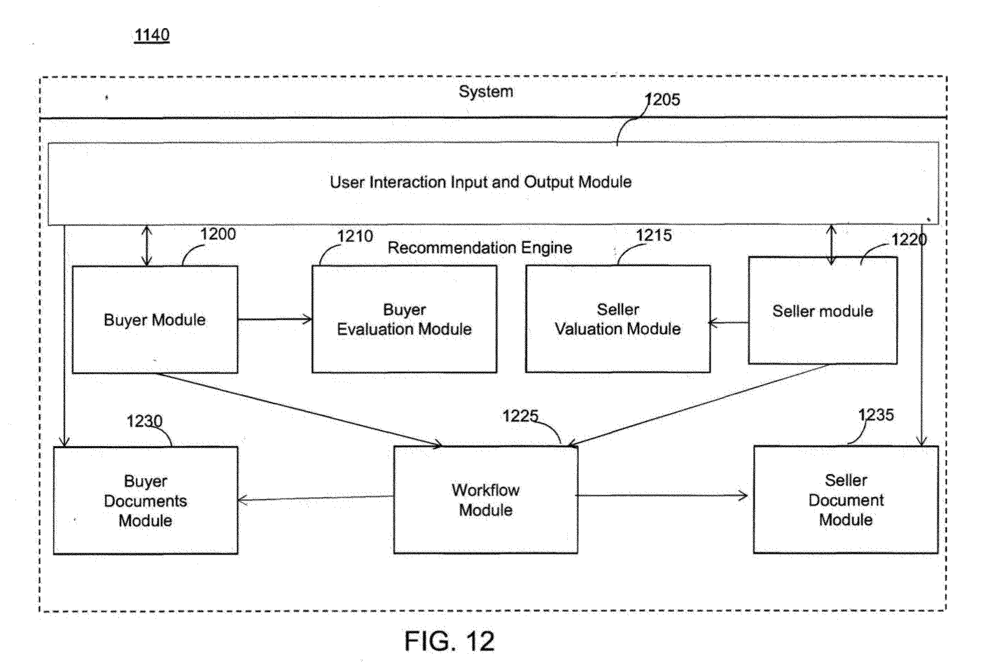

FIG. 12 is an exemplary block diagram of system 1140 of the present invention. In some embodiments, and as discussed herein, system 1140 is accessible via network 1110a and/or network communication interface 108 (as shown in FIG. 1). System 1140 may include client module 1205 (also referred to herein as “client interaction module” “user interaction input and output module” and/or “client interface”), buyer process module 1200 (also referred to herein as “buyer module”), seller process module 1220 (also referred to herein as “seller module”), buyer evaluation module 1210, seller evaluation module 1215, workflow module 1225, buyer documents module 1230, and/or seller document module 1235. As discussed herein, client module 1205 may include a GUI. Preferably, and as discussed herein, buyer process module 1200 may include a search engine or module so that the buyer may search property and may be provided with a list of one or more properties. Additionally, buyer process module 1200 may enable buyer to prepare an offer and initiate processes involved in workflow module 1225. Preferably, and as discussed herein, seller process module 1220 may enable seller to list property on the market by electronically signing an agreement to that effect. Upon signing the agreement, preferably, the property would be displayed in the search results. Preferably, seller valuation module 1215 is configured to provide seller an opinion of valuation, as discussed further below. Preferably, workflow module 1225 manages and organizes the workflow between buyers and sellers in a commercial real estate transaction, by managing interactions and documents between the foregoing parties. Workflow module 1225 may utilize one or more workflow engines such as, but not limited to, BPM (business process management); rule-based engines, document management systems, and/or notification systems to manage the commercial real estate transaction process between buyers and sellers.

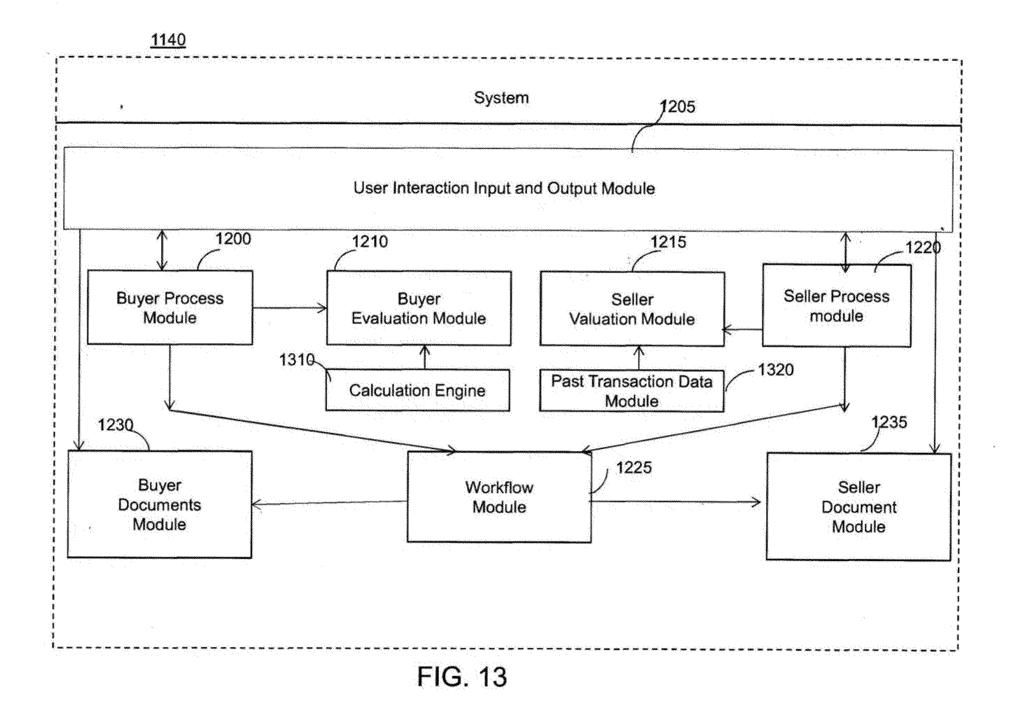

FIG. 13 is an exemplary block diagram of system 1140 of the present invention, including a calculation engine 1310 (for use, preferably, in connection with “what if” scenario calculator) and a historical data module 1320 (for use, preferably, in connection with seller valuation). Both of the foregoing will be discussed further herein.

FIG. 14 is an exemplary block diagram of system 1140 of the present invention, showing document generation modules 1410 and 1420 and a communication module 3430. Both of the foregoing will be discussed further herein.

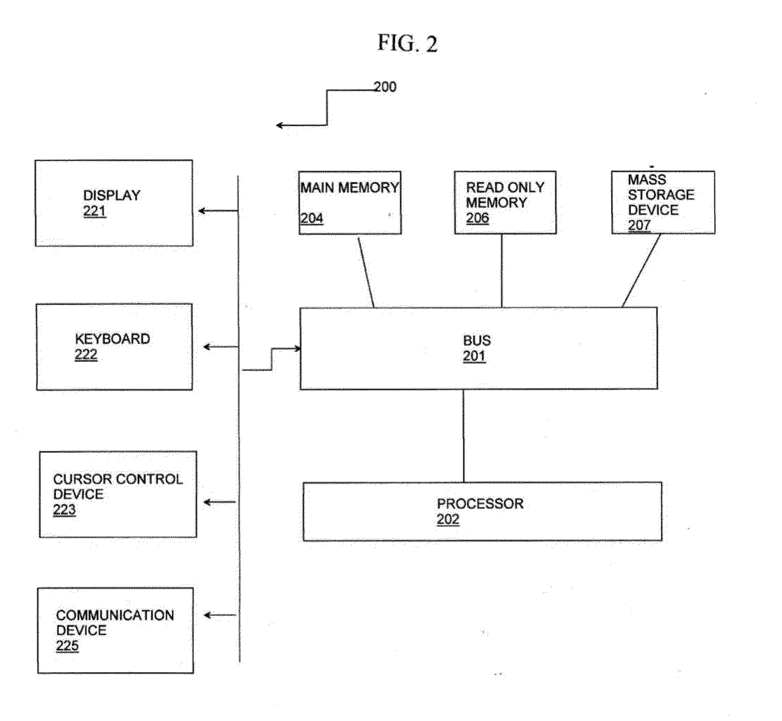

FIG. 2 illustrates an example of a computer system 200 in which the features of the present invention may be implemented. The computer system 200 may include a bus 201 for communicating information between the components in the computer system 200, and a processor 202 coupled with the bus 201 for executing software code, or instructions, and processing information. The computer system further compromises a main memory 204, which may be implemented using random access memory (RAM) and/or other random memory storage device, coupled to the bus 201 for storing information and instructions to be executed by the processor 202. The main memory 204 also may be used for storing temporary variables or other intermediate information during the execution of instructions by the processor 202. The computer system 200 may also include a read only (ROM) and/or other static storage device coupled to the bus 201 for storing static information and instructions for the processor 202.

Another type of user input shown in FIG. 2 is a cursor control device 223, such as a conventional mouse, touch mouse, trackball, track pad, or other type of cursor direction keys for communicating direction information and command selection to the processor 202 and for controlling movement of a cursor on the display 221. Although not illustrated, the computer system 200 may optionally include video, camera, speakers, sound cards, and the like. Various types of input devices, including, but not limited to, the input devices described herein, may allow the user to provide command or input to the computer system 200. For example, in the various descriptions contained herein, reference may be made to the user “clicking,” “selecting”, or “inputting” and any other grammatical versions thereof, one or more items in a user interface. These should mean that the user is using one or more input devices to accomplish the input.

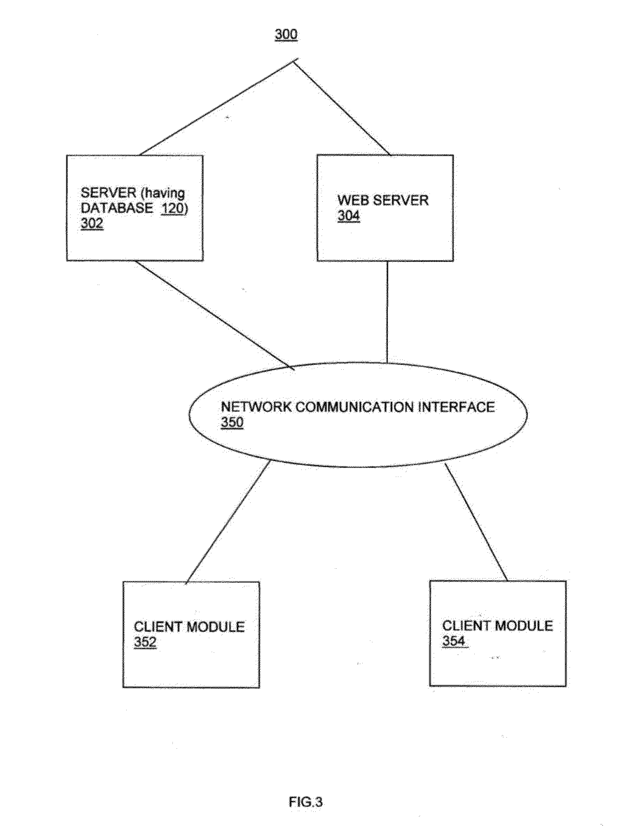

In some embodiments, FIG. 3 illustrates a computer network including a server system 300 having a database server 302 for storing a database 120 and a web server 304 that stores the instructions necessary to access and present the information from, as well as store information into, the database 120. The user, using a client computer such as a client module 352 and a client module 354, may access server system 300 through a network communication interface 350. Other systems, such as those belonging to a manufacturer, may also be coupled to the server system 300. In the illustrated embodiment, the network communication interface 350 represents a variety of networks that may include one or more local area networks as well as wide area networks. The functionality provided by the database server 302, the web server 304, the client module 352, and the client module 354 as well as by the manufacturer, may be implemented using a computer system having the characteristics of the computer system 200 described herein. It should be noted, however, that specific implementation of the computer system or systems used to describe the present invention is not to be limiting unless specifically noted. For example, the functionality provided by the database server 302 and the web server 304 may be offered by one computer system. Further, the functionality provided by the database server 302 and web server 304 may be redistributed over several computers.

In some embodiments, the user (i.e., the buyer or seller) may interact with the information stored in the database through the GUI. In the following description, the GUI is implemented using one or more web pages (which may be referred to herein as “pages,” “screens,” or “forms”) provided by the web server 304 accessible by the user using any Internet web browser software, such as the Internet Explorer browser provided by Microsoft Corp., on a computer such as the client module 352 or a mobile device. In some embodiments, one or more custom software programs can be created to implement the system described herein. Of course, the web server 304 may itself have browser software installed on it so as to be accessed by the user. Further, throughout the description of the various embodiments of the invention herein, references are made to the user performing such actions as selecting buttons or clicking on, executing searches or updates on the database. In some embodiments, these requests are generated by the user interacting with the browser. Preferably, the one or more web pages described herein may include a form interface (e.g., a drop down menu, a radio button selection, etc.). Once the user has provided such a selection, the user may select a button or a link on the web page to request an update of the database with the information. The browser will send the web server 304 a link that includes the information (i.e., the user's selection) being sent as well as a request to update the database. It is to be understood that any form interface now known or later contemplated may be used.

Throughout the description of the various embodiments of the invention described herein, references are made to the website or interface “updating” or any grammatical version thereof. This reference preferably means that the system is taking note of the new information and updating, for example, the transaction history database (or any other database), regarding new information. These “updates” may be triggered manually, automatically, and/or passively. As used herein, “manually,” or any grammatical version thereof, refers to one or more individuals interacting with the website to update, for example, a property listing. For example, a seller may input property information. The seller may be provided with a button, such as a “submit button” to “update” or “refresh” the property listing to reflect the inputted property information. As used herein, “automatically,” or a grammatical version thereof, refers to a website updating, for example, a property listing on its own. The website may “update” to reflect this transaction.

In some embodiments, the system and methods of the present invention may be accessible via the inventive website through cloud computing (i.e., a virtual server). For example, cloud computing may provide a secure server for a seller, buyer, and the like.

Cloud computing may serve to store and operate all of the GUIs, software, and databases. In other embodiments, cloud computing may not be used, or may be partially used. In this instance, the server may not be a virtual server. As such, the server may be a physical computer having Internet access. In some embodiments, the system and method of the present invention may be implemented using an application on a mobile device.

The present invention is directed to a system and method of managing a real estate and/or a business transaction process between a buyer and a seller (it is to be understood that the system may be configured to manage both a real estate and a business transaction or one or the other). An exemplary real estate transaction is a commercial real estate transaction. An exemplary commercial real estate transaction is in the hospitality market, such as a hotel or motel transaction. It is to be understood, however, that the invention is not limited to the hospitality market. The invention may provide real estate transactions services in the field of residential real estate and/or other commercial real estate without departing from the scope of the present invention. For example, the transactions may be directed to the convenience store market, restaurants, or the like. Additionally, it is to be understood that the invention is not limited to real estate transactions, but can be applicable to business transactions as well. Use of the terms “real estate transaction” or “commercial real estate transaction” is used for ease of reference throughout the description. “Business transaction,” as used herein, may refer to purchase of a new and/or existing business (where a lease may or may not be a part of the assets sold). For example, a business transaction related to a Subway franchise purchase may entail the sale of equipment, inventory, and the like. The business transaction may or may not include sale of the land or sale of the building housing the Subway franchise.

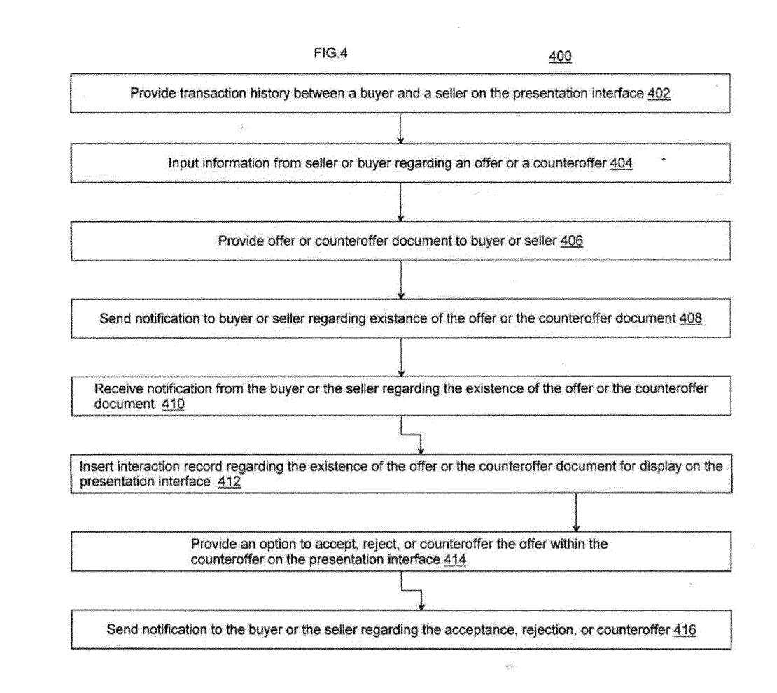

In the following description, the invention may be described by a series of exemplary steps as shown in FIGS. 4-8. It is to be understood that the invention is not limited to these steps, and one or more of the steps may be omitted, replaced, and/or conducted in a different order without departing from the scope of the present invention.

Referring to FIG. 4, the system (i.e., the administrative interface) may be configured to perform one or more of the following steps (identified herein as “400”). In a first step 402, the system may be configured to provide transaction history between a buyer and a seller on the presentation interface. Thereafter, in a second step 404, the system may be configured to input information from the seller or the buyer regarding an offer or a counteroffer. In a third step 406, the system may be configured to provide an offer or a counteroffer document to the buyer or the seller. In a fourth step 408, the system may be configured to send notification to the buyer or the seller regarding the existence of the offer or the counteroffer document. In a fifth step 410, the system may be configured to receive notification from the buyer or the seller regarding the offer or the counteroffer document. Thereafter, the system may be configured to insert an interaction record regarding the existence of the offer or the counteroffer document on the presentation interface, in sixth step 412. In a seventh step 414, the system may be configured to provide the option to accept, reject, or counteroffer the offer or the counteroffer document within the presentation interface. In an eighth step 416, the system may be configured to send notification to the buyer or the seller regarding the acceptance, rejection, or counteroffer.

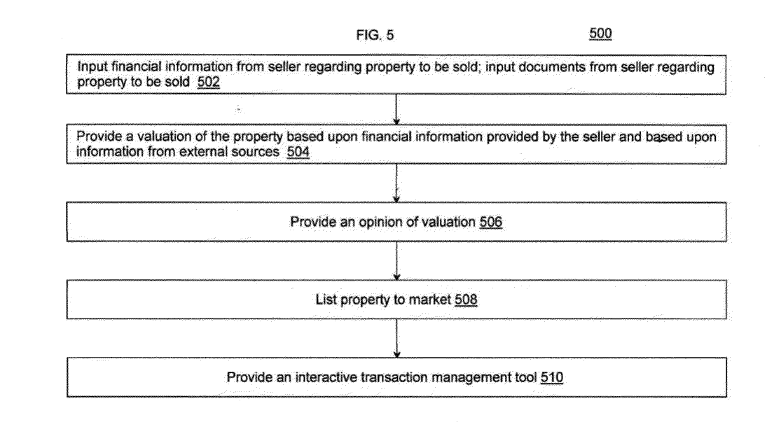

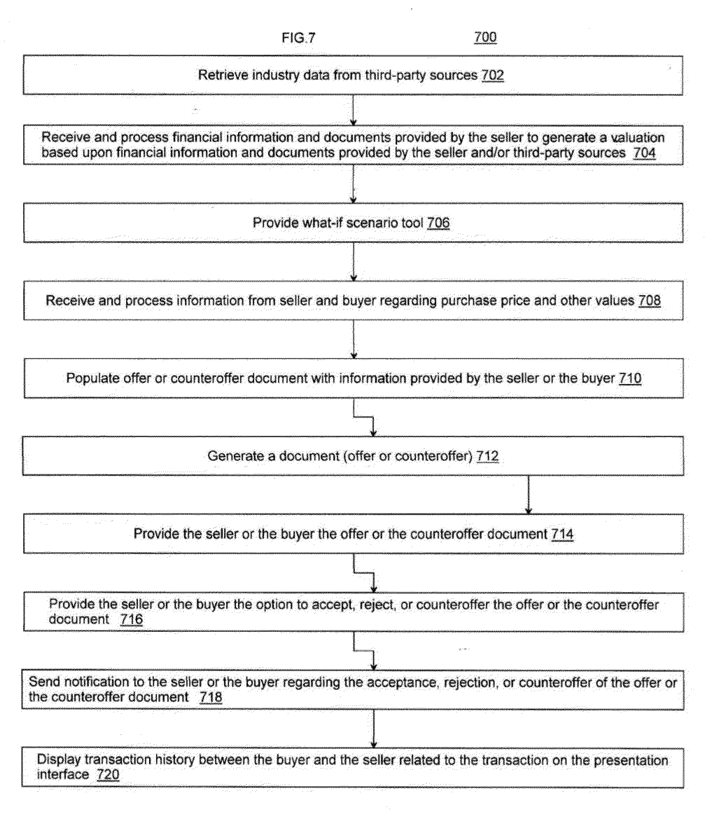

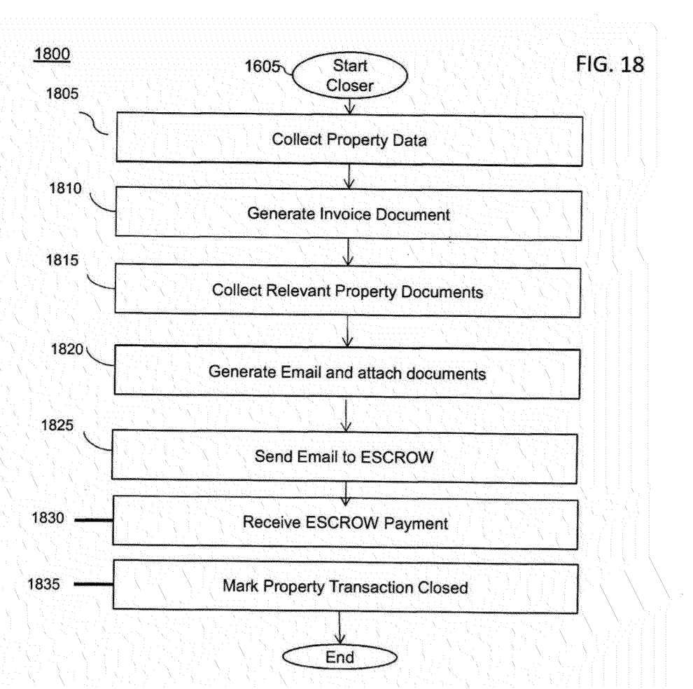

Referring to FIG. 5, the system (i.e., the presentation interface, preferably as it relates to the seller), may be configured to perform one or more of the following steps (identified herein as “500”). In a first step 502, the system may be configured to input financial information and/or documents from the seller regarding a property to be sold. In a second step 504, the system may be configured to provide a valuation of the property based upon financial information and/or documents provided by the seller and/or based upon information from external sources. Thereafter, in a third step 506, the system may be configured to provide an opinion of valuation, an actual document that the seller may show to interested parties. In a fourth step 508, the system may be configured to list the property to market, i.e., list property to market with one or more listing services. In a fifth step 510, the system may be configured to provide an interactive transaction management tool (described in FIGS. 7 and 18).

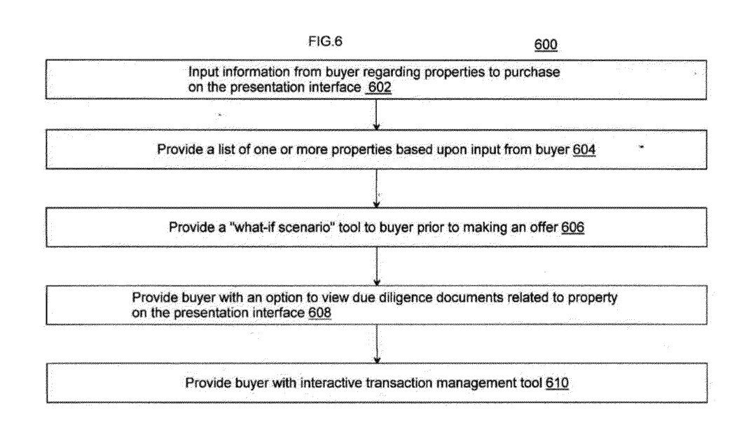

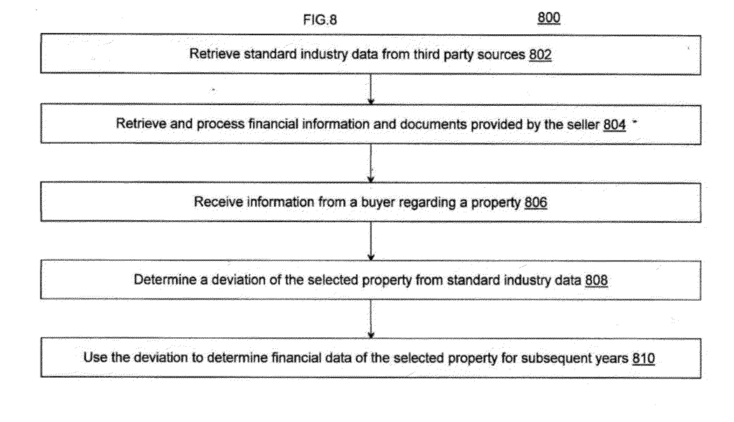

Referring to FIG. 6, the system (i.e., the presentation interface, preferably as it relates to the buyer), may be configured to perform one or more of the following steps (identified herein as “600”). In a first step 602, the system may be configured to input information from the buyer regarding desired properties. In a second step 604, the system may be configured to provide/display one or more properties based upon input from the buyer regarding desired properties. Thereafter, the system may be configured to provide a “what-if-scenario” tool to the buyer, preferably before making an offer, in a third step 606. FIG. 8 describes the “what-if-scenario” tool in detail. In a fourth step 608, the system may be configured to provide the buyer with an option to view due diligence documents (or other documents related to the desired property) from the presentation interface. In a fifth step 610, the system may be configured to provide an interactive transaction management tool (described in FIGS. 7 and 18).

Referring to FIG. 7, the system (preferably, the administrative interface), may be configured to perform one or more of the following steps in any order (identified herein as “700”). In a first step 702, the system may be configured to retrieve industry data from third party sources. In a second step 704, the system may be configured to receive and process financial information and documents provided by the seller to generate a valuation based upon financial information and/or documents provided by the seller, and/or based upon industry data from third party sources (retrieved in the first step). Thereafter, in a third step 706, the system may be configured to provide a “what-if scenario” tool (described in FIG. 8). In a fourth step 708, the system may be configured to receive and process information from the seller and/or the buyer regarding purchase price and other values related to the commercial transaction. Thereafter, the system may be configured to populate an offer and/or a counteroffer document with the information, in a fifth step 710. In a sixth step 712, the system may be configured to generate an offer or a counteroffer document. In a seventh step 714, the system may be configured to provide the seller or the buyer the offer and/or the counteroffer document. In an eighth step 716, the system may be configured to provide the seller or the buyer the option to accept, reject, or counteroffer the offer or the counteroffer document. In a ninth step 718, the system may be configured to send notification to the seller or the buyer regarding the acceptance, rejection, or counteroffer of the offer or the counteroffer document. Thereafter, in a tenth step 720, the system may be configured to display the transaction history between the buyer and the seller related to the transaction within the presentation interface. It is possible that the seller may be engaged in selling more than one property, may be engaged in entertaining more than one offer for a specific property, and/or may be a buyer in other transaction(s). In this instance, the system may be configured to display all transactions that the seller is engaged in. Similarly, it is possible that the buyer may be engaged in sending offers to more than one seller (regarding more than one property) and/or may also be engaged in selling other properties. If so, the system may be configured to display all the transactions that the buyer is engaged in (including ones wherein the buyer is a seller).

Referring to FIG. 8, the system (preferably, the administrative interface), may be configured to perform one or more of the following steps in any order (identified herein as “800”). In a first step 802, the system is configured to retrieve standard industry data from third party sources. For example, the standard industry data may include data regarding hotel vacancy rate in a particular geographic area. In a second step 804, the system may be configured to receive and process financial information and documents provided by the seller. Thereafter, in a third step 806, the system may be configured to receive information from a buyer regarding a selected property (i.e., this may include the identity of a selected property). In a forth step 808, the system may be configured to determine a deviation of the selected property from standard industry data. In a fifth step 810, the system may use the deviation to determine financial data of the selected property for subsequent years. For example, the standard industry data may be hotel vacancy rate in a particular geographic area. If the selected property vacancy rate is 25%, and the standard industry rate is 20% (of a similar property in the same geographic area), then the selected property's vacancy rate is 125% more. Calculations such as the foregoing may be done for each parameter/data. Further, if the projected standard industry vacancy rate for the following year (of a similar property in the same geographic area) is 10%, then the vacancy rate of the selected property may be 1.25 times more (or 12.5%).

### Exemplary Log-In Screen

In some embodiments, and referring to FIG. 14, the system and method of the present invention includes the step of providing, in a computer or a mobile device, client interaction module 1205 (or client GUI or interface). In these embodiments, a seller or buyer may be directed to a website, i.e., the inventive website of the present invention (i.e., the presentation interface). Preferably, client interaction module 1205 allows the seller or buyer to login. If the seller or buyer has never logged in to the website before, the seller and/or buyer may be directed to register. If the seller and/or buyer has already registered, the seller and/or buyer may be directed to log-in. To log-in, a seller and/or buyer may enter or input a valid username and password into respective username (or email) and password fields. The log-in screen may provide a link if the seller or buyer forgets his or her username and/or password. Upon entering a username and password, the seller or buyer may then select a log-in button to proceed. The website may identify user as a seller or a buyer, and not an agency employee. As such, the seller and buyer home page may be displayed upon log-in.

### Exemplary Buyer and Seller Homepage

The homepage (or other Internet webpage) may be configured to provide the buyer and/or seller a number of options, such as, “buying property,” “selling property,” “my properties,” “my watch list,” “my tasks/calendar,” “transaction activities,” and/or “user profile.” In some embodiments, the buyer and/or seller may be provided with, or the website may be configured with, a “help” feature or tool in the form of a drop down menu of topics, or the like. This “help” feature may include a live chat service. Further, the buyer or seller may be provided with a screen to enter his or her account information if he or she has not already done so. This account information may include identifying information, such as street address, client type (buyer, seller, developer, manager, or the like). The system may thereby update to reflect the additional account information. The client account information may be located in a client account database. The client may be able to update his or her account information at any time.

### Seller Module

In some embodiments, and referring to FIG. 12, system 1140 of the present invention includes a seller module 1200. Seller module 1200 may be configured to receive information from the seller. In this regard, the system and method of the present invention includes the step of receiving, in a computer or a mobile device, information from one or more sellers regarding a property (or other asset). Preferably, the system or webpage is configured to receive information from one or more sellers regarding a property or other asset. This information may include, but is not limited to, property name, brand, property type (i.e., full service, limited service, boutique, bread & breakfast, and the like), lot size, building size, number of rooms (i.e., for motels/hotels), property details, and the like. In this regard, a fillable form with one or more drop down boxes, or other form interface, may be provided. Of course, the foregoing details will vary depending on the type of property or asset that is the subject of the transaction.

In some embodiments, after seller input of the basic details regarding the property to be sold, the seller may select a “submit” button, or the like. Thereafter, the website may direct the seller to another webpage. This webpage may be configured to receive additional details regarding the property or other asset. In this regard, the webpage may be configured to receive location details regarding the property. For example, the webpage may be configured to receive information such as, but not limited to location details such as the location of the property relative to an airport; the location of the property relative to downtown; the location of the property relative to landmarks; the location of the property relative to a freeway; amenities at the property [(such as, but not limited to, a pool, hot tub, restaurant (and whether the restaurant is owned and operated or leased), availability of breakfast (i.e., whether the property provides a “continental breakfast”), presence of bar (i.e., full service bar, bar service leased out, bar with liquor license), presence of fitness center (and whether there is a sauna and steam room), presence of banquet/conference center, and/or business center]. Additionally, the website may be configured to receive information regarding the “demand” potential of the property. Parameters to determine demand include, but are not limited to, whether one or more of the following is near the property, and, if so, whether one or more of the following is adjacent, walking distance, or driving distance from the property: an upscale shopping center; a neighborhood shopping center; industry; employment; government; convention center; major transportation; local transportation; commercial buildings; a university; a college; a hospital and/or medical center; and/or a sports complex. Of course, the foregoing details will vary depending on the type of property or asset that is the subject of the transaction.

In some embodiments, the system and method of the present invention includes the step of generating, in a computer or a mobile device, a written description of the property or other asset based upon the location details and/or the demand potential of the property as discussed above. This written description may be provided with the property listing. In other embodiments, the step of generating, in a computer or a mobile device, a written description of the property is omitted.

In some embodiments, the system and method of the present invention includes the step of receiving, in a computer or a mobile device, financial information regarding the property or other asset. Preferably, this financial information is used to generate an opinion of valuation for the seller and/or a “what-if scenario” tool or calculator for the buyer (as shown in FIG. 8). Financial information may include, for example, room revenue for the last four years (or any other time period); F&B (food and beverage); other income; total revenue for the last four years (or any other time period); expenses for the last four years (or any other time period); and/or net operating income (for the last four years or any other time period). The foregoing parameters are representative parameters for the hospitality industry (i.e., for hotel and motel properties). It is to be understood, however, that the parameters may vary depending on the type of property (and whether it is real property or other asset) being sold. In other embodiments, the step of receiving, in a computer or a mobile device, financial information regarding the property or other asset is omitted.

In some embodiments, the system and method of the present invention includes the step of receiving, in a computer or a mobile device, property images of property or other asset to be sold. In other embodiments, the step of receiving, in a computer or a mobile device, property images is omitted.

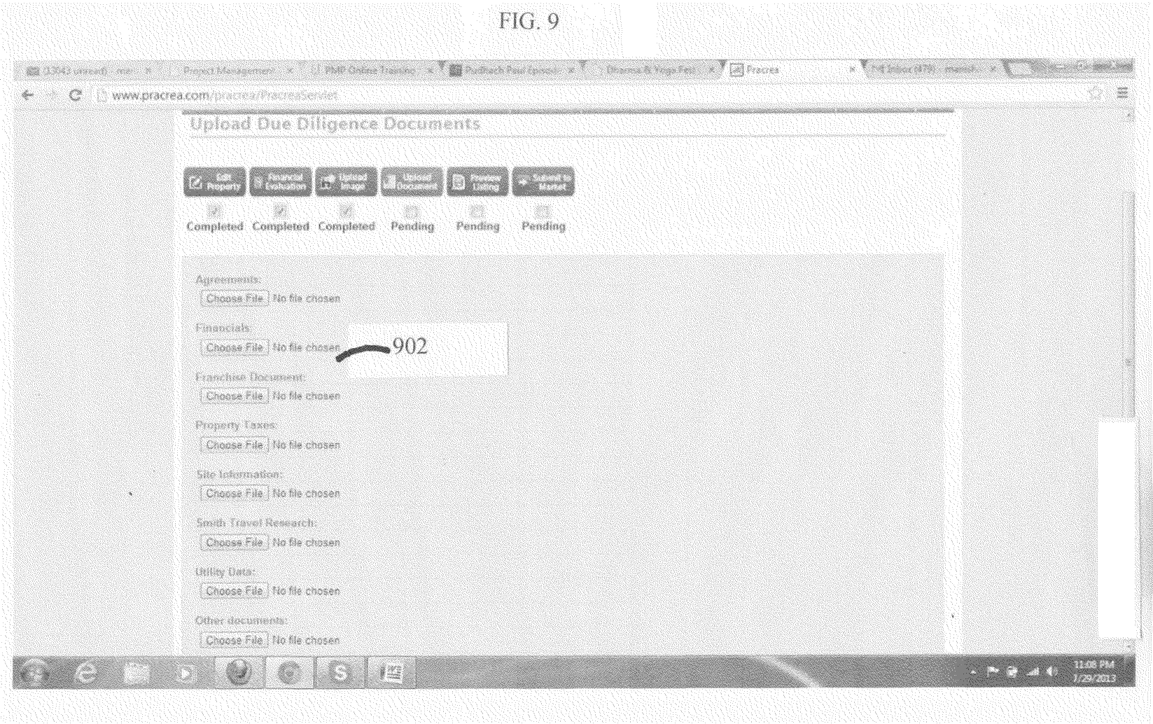

In some embodiments, the system and method of the present invention includes the step of receiving and storing, in a computer or a mobile device, due diligence documents regarding a property, or other asset, intended to be sold. In this regard, the system or website is configured to receive documents related to the real estate transaction, i.e., related to the hospitality transaction. For example, due diligence documents related to a hotel or a motel property may be uploaded directly to the website as shown in FIG. 9 (and step 902). In this regard, these documents are stored within the website for any period of time. Preferably, these documents may be removed and/or replaced at any time by the seller or other user having control over the documents. These documents may be used to determine the valuation of the property. In some embodiments, and as discussed further below, the buyer may request to view one or more of the due diligence documents. The buyer may be able to view the documents directly from the website (and without leaving the website). In this regard, due diligence documents are easily transferred between parties to a real estate transaction and/or business transaction. Due diligence documents may be, but are not limited to, agreements, financials, franchise documents, property taxes, site information, Smith Travel Research documents or information; utility data, and/or any other documents.

In some embodiments, the system and method of the present invention includes the step of providing, in a computer or a mobile device, a seller checklist to confirm that required property information, images, and documents have been uploaded. Additionally, preferably, the system is configured to provide the seller with an agreement to electronically sign prior to submission to market. In other embodiments, the step of providing a seller checklist is omitted.

### Seller Valuation Module and Historical Data Module

In some embodiments, and referring to FIG. 13, system 1140 is configured to include a seller valuation module 1215 and/or a historical data module 1320 to provide the seller with a valuation of the property or other asset. In this regard, the valuation may be determined by information provided by the seller and/or historical information from external sources. In some embodiments, the system and method of the present invention includes the step of determining and generating, in a computer or a mobile device, a valuation of the property or other asset. In this regard, the system or the website is configured to determine the valuation of the property and generate a valuation of the property or other asset. This may include the step of receiving and using information from the seller. This information may include, but it not limited to, financial information for the property (as discussed above) for the last three years (or any other time range) and/or due diligence documents provided by the seller. The foregoing may be stored in and/or retrieved from, for example, the seller valuation module 1215.

Preferably, historical data module may be configured to receive and store information from external sources to assist, for example, in the valuation. Historical data module 1320 may integrate with other data sources such as, but not limited to, locality information, STR, Costar, and the like to retrieve historical data of property transactions. Historical data may be retrieved from variety of sources, including, but not limited to, PKF Consulting, Smith Travel Research, Lodging Econometrics, Real Capital Analytics, and HVS Consulting. It is to be understood that historical data module 1320 may interact with external data sources using methods known in the art, such as, but not limited to, APIs, adapters, database queries, catalog searches, semantic searches, RSS feeds and/or Lucene/SOLR-based catalog search for property information, and the like. For example, average PPR (price per room), RRM (room revenue multiplier), and CAP rate identified by city or zip code may be computed from historical transactions. These parameters may be used in calculating the valuation of a property. Accordingly, valuation may be calculated by using sales comparable and multipliers based upon the financial performance of the property (i.e., RRM and cap rate returns which use net operating income as the numerator) as well as historical (industry) data from external sources.

Preferably, the due diligence documents may be uploaded directly to the website for easy access as discussed above. Preferably, these documents are only viewable by the seller and the agency (and others that are approved by the seller). Preferably, the step of determining and/or generating the valuation includes the step of determining the valuation online, automatically (as used in the valuation context, “automatically” means “via a computer or a processor”), and instantaneously, once the requested information from the seller is received. In this regard, the system or website is configured to determine and/or generate the value of the property automatically, i.e., via one or more algorithms, as well as via historical data. In this manner, the value of the property may be provided to the seller, preferably instantaneously upon request. The seller may be provided with the valuation online (i.e., on the website). Additionally, the system and method of the present invention may include the step of generating and/or providing a letter having the valuation (i.e., an opinion of valuation). In other embodiments, the step of determining and generating, in a computer or a mobile device, a valuation of the property or other asset is omitted. In yet other embodiments, the step of determining and/or generating the valuation of the property is not done automatically, i.e., it is done manually. For example, an individual may determine the valuation of the property based upon information provided by the seller or other information. In this regard, an algorithm may or may not be used to determine the valuation of the property. In yet other embodiments, the valuation is not provided online and/or not provided instantaneously.

In some embodiments, the system and method the present invention includes the step of providing, in a computer or a mobile device, a minimum valuation of the property (or other asset) and a maximum valuation of the property (or other asset). Preferably, the minimum and maximum valuations are provided online, automatically, and instantaneously. The seller may use the minimum and maximum values to determine the appropriate selling price of the property; however, the seller does not have to use these values. Preferably, these values are merely guidelines for the seller. In other embodiments, more than two values for the property may be provided. For example, low, medium, and high values may be provided. In other embodiments, the step of providing, in a computer or a mobile device, a minimum valuation of the property and a maximum valuation of the property (or other asset) is omitted.

In some embodiments, the system and method of the present invention includes the step of providing, in a computer or a mobile device, an opinion of valuation. The opinion of valuation may be an actual document that can be shown to third parties. The opinion of valuation may include price, cap rate, room revenue multiplier, and/or price per room. In other embodiments, the step of providing an opinion of valuation is omitted.

In some embodiments, the system and method of the present invention includes the step of determining, in a computer or a mobile device, a valuation of the property based on the total revenue and total income of the property, as preferably described below.

Total Revenue=Room Revenue+Food and Beverage (F&B) Revenue

Net Operating Income (NOI)=Total Revenue−Total Expenses without Interest, Taxes, Amortization and Depreciation

Prorated Net Operating Income=(Total YTD NOI/YTD Months)×12 (wherein “YTD” stands for “year-to-date”

In some embodiments, the average net-operating income and the average revenue may be calculated in the following manner:

avgNOI=((ytdNOI+y1NOI+y2NOI+y3NOI)/incYears); where “avgNOI” stands for “average net operating income;” “ytdNOI” stands for “year-to-date net-operating income;” “y1Inc” stands for “year 1 net-operating income;” “y2Inc” stands for “year two net-operating income;” and “y3Inc” stands for “year three net-operating income.”

avgRRev=(ytdRRev+y1RRev+y2RRev+y3RRev)/incYears; where “Avg RRev” stands for “average revenue,” “ytdRRev” stands for “year to date revenue;” “y1RRev” stands for “year 1 revenue;” “y2RRev” stands for “year 2 revenue;” and “y3RRev” stands for “year 3 revenue.”

In some embodiments, the system and method of the present invention includes the step of determining, in a computer or a mobile device, the valuation of the property based upon the algorithms below (avgNOI and avgRev determined as described above).

$$\underline{Premium Independent}$$

$$midValue = Math . round ( ( WeightPICAP * avgInc * 100 / locCap ) + ( WeightPIRRM * locRrm * avgRRev ) + ( WeightPIPPR * locPpr * rooms ) ) ;$$

$$\underline{Independent} \text{:}$$

$$midValue = Math . round ( ( WeightICAP * avgInc * 100 / locCap ) + ( WeightIRRM * locRrm * avgRRev ) + ( WeightIPPR * locPpr * rooms ) ) ;$$

$$\underline{Premium Franchise} \text{:}$$

$$midValue = Math . round ( ( WeightPFPPR * avgInc * 100 / locCap ) + ( WeightPFRRM * locRrm * avgRRev ) + ( WeightPFPPR * locPpr * rooms ) ) ;$$

$$\underline{Other Franchise} \text{:}$$

$$midValue = Math . round ( ( WeightOFCAP * avgInc * 100 / locCap ) + ( WeightOFRRM * locRrm * avgRRev ) + ( WeightOFPPR * locPpr * rooms ) ) ;$$

In some embodiments, “premium independent,” “premium franchise,” “other franchise,” each refer to hotel or motel brand types. These classifications may be akin to hotel/motel star levels.

In some embodiments, the system and method of the present invention includes the step of determining, in a computer or a mobile device, a minimum and a maximum value of the property. Preferably, the formula below is used:

Minimum, Mid and Maximum Values:

Min=MinMult×midValue

Max=MaxMult×midValue

In some embodiments, the system and method of the present invention includes the step of providing the seller with an option to discuss the valuation with the agency. Discussions may take place via chat service, phone call, and/or electronically. It is to be understood that the foregoing is only exemplary, and the algorithm may vary based upon the type of property or other asset that is the subject of the valuation. In other embodiments, the step of providing the seller with an option to discuss the valuation is omitted.

### Seller Module: Placing Property on Market

In some embodiments, the system and method of the present invention includes the step of receiving and/or submitting, in a computer or a mobile device, the property (or other asset) to the market. In this regard, the system and/or website may be configured to receive property listings from a seller. In this regard, the seller may be able to provide details regarding the property (or other asset) as well as a selling price, online. After providing details regarding the property, the seller may be able to select a “submit” button, or the like, to list the property on the website. Before the listing goes “live” the seller may be able to preview the listing. If the seller agrees with the property listing, he or she may click on a “submit” button, or the like. Thereafter, the seller may be directed to a webpage showing tasks completed and confirming that the property has been submitted to the market. It is to be understood that the seller may request that the property be “de-listed” at any time or any specified time. In other embodiments, the step of receiving and/or submitting, in a computer or a mobile device, the property to market is omitted.

In some embodiments, the system and method of the present invention includes the step of providing the seller with a list of his or her (or its) properties (or other assets) currently on the market.

### Buyer Module and Buyer Evaluation Modules

In some embodiments, and referring to FIG. 14, system 1140 includes buyer module 1200 and/or buyer evaluation module 1210. Buyer evaluation module 1210 may include what-if scenario calculator 1210 as discussed further below. In this regard, the system and method of the present invention includes the step of providing, in a computer or a mobile device, a list of one or more properties for the buyer to purchase. Preferably, the system and method of the present invention includes the step of receiving, in a computer or a mobile device, information from a buyer regarding a desired property (i.e., a hotel or a motel or other asset). The buyer may be able to select “buying property” from the homepage. Thereafter, the buyer may be able to provide information regarding a property of interest. In this regard, the system or website may be configured to receive the following information from the buyer: brand (i.e., brand of hotel or motel); state of desired property; price per room (for hotels and motels); room revenue multiplier (value=room revenue×room revenue multiplier); cap rate; number of rooms (i.e., number of motel or hotel rooms); property type (i.e., full service, limited service, boutique, bread & breakfast); listing type (i.e., general, bank-owned, distressed, foreclosure, auction), and/or price range (i.e., minimum and maximum values), and the like. The foregoing information may be received via drop down selections, or the like. In some embodiments, the buyer may be able to provide additional “keywords” to assist in the search. Upon receipt of this information, a list of one or more properties may be generated. For example, if the desired property is a hotel or a motel, then the buyer may be directed to a webpage having one or more hotels or motels. The buyer may thereafter select a property from the list by clicking, for example, on the property name. In this regard, the system or webpage is configured to receive information from a buyer regarding a selected property. Preferably, this webpage has more information regarding the selected property. In other embodiments, the step of receiving, in a computer or a mobile device, information from the buyer regarding a desired property is omitted.

### What-if Scenario Tool or Calculator

In some embodiments, and referring to FIG. 13, system 1140 of the present invention includes a what-if scenario calculator 1310 (or tool). What-if scenario calculator may be able to provide the buyer with a valuation of a selected property or other asset, as well as future profit potential of the selected property or other asset. What-if scenario calculator 1310 may utilize rule-based implementation and/or Drool, RETE, Groovy, and the like, to compute the valuation, as well as future earning potential, of the selected property. Parameters used to conduct the “what-if” analysis may include purchase price and/or conversion of the franchise/property (i.e., updates to the property). It is to be understood that any valuation parameters and/or algorithms and/or historical data/industry standards described herein and used to provide the seller with a valuation may be used to provide the buyer with a valuation. A profit-loss scenario may be analyzed for a particular hotel property. This may be provided to the buyer online. In other embodiments, the what-if-scenario calculator is omitted.

### Document Module and Document Generation Module

In some embodiments, and as shown in FIG. 12, the system and method of the present includes the step of providing, in a computer or a mobile device, document modules 1230 and 1235 (although described by different numerical identifiers, it is to be understood that document modules 1230 and 1235 may be the same or different). In some embodiments, document modules 1230 and 1235 may use a template-driven approach to generate documents and/or may use third party tools and their application programming interfaces, or APIs, to generate documents. Additionally, document modules 1230 and 1235 may manage storage of documents and determine/control which buyer and/or seller may have access to them. In some embodiments, document module 1230 and/or 1235 may be omitted.

In some embodiments, and as shown in FIG. 14, the system and method of the present invention includes the step of providing, in a computer or a mobile device, buyer document generation module 1410 and seller document generation module 1420 (collectively may be identified as “document generation modules”). Preferably, at document generation module 1410, documents typically initiated by a buyer in a real estate transaction and/or business transaction are generated. The type and/or substance of these documents may be dictated by, for example, the type of property that is the subject of the transaction. Examples of documents that may be initiated by a buyer are Letter of Intent (Offer) and a Purchase Sale Document. Preferably, at document generation module 1420, documents typically initiated by a seller in a real estate transaction are generated. The type and/or substance of these documents may be dictated by, for example, the type of property that is the subject of the transaction. Examples of documents that may be initiated by a seller are Purchase Sale Documents and Counteroffers. Buyer document generation module 1410 and seller document generation module 1420 may generate documents in various formats, such as, but not limited to, “doc,” “rtf,” “pdf,” and the like. Additionally, document generation modules 1410 and/or 1420 may utilize APIs and/or tools such as, but not limited to, OpenText, PdfBox, and the like.

In some embodiments, the system and method of the present invention includes the step of providing the buyer with an option to view documents regarding the property online; view financial information regarding the property online, and/or make an offer online. In this regard, the system and/or website is configured to provide the buyer with an option to view documents regarding the property online (i.e., the “option” being a “view documents” tab or the like); to provide the buyer with financial information provided by the seller online; and/or to receive an online offer from the buyer.

In some embodiments, the system and method of the present invention includes the step of receiving a request from a buyer to view documents regarding the selected property. Preferably, the buyer is able to view documents online and within the website itself. As such, the flow of the documents, many of them confidential is controlled. For example, should the buyer want to review documents regarding a selected property online (i.e., through the website), the buyer may be able to select a “view documents” tab, or the like. Preferably, the buyer's request to view documents is sent electronically to the seller. Preferably, the seller receives notification of this request through the website (i.e., when he or she logs in). In other embodiments, the seller may receive this notification electronically via his or her personal email account. The seller may choose to accept the buyer's request to view documents, or the seller may choose to decline the buyer's request to view documents. After selecting the “view documents” feature, the buyer may be directed to a non-disclosure agreement. Thereafter, the buyer may be notified that his or her request to view documents related to the selected property was sent successfully. In this regard, the system and method of the present invention includes the step of providing the buyer with the option to view the documents online if the seller consents. The actual receipt and review of these documents will be discussed further below.

In some embodiments, the system and method of the present invention includes the step of generating, in a computer or a mobile device, and receiving, in a computer or a mobile device, a letter of intent (or offer) from the buyer. Preferably, the offer is generated online and within the website itself. Preferably, the offer is in the form of a document. Preferably, this offer is a legal document. In this regard, the system and/or website is configured to generate an offer (i.e., an offer letter) and receive an offer from the buyer. For example, the buyer may select “make an offer” within the presentation interface. Thereafter, the buyer may be provided with a couple of options. The buyer may select “generate and send LOT” (“letter of intent”) and/or “upload and send LOT.” If the buyer selects “generate and send LOT,” then the buyer may be directed to another webpage. Within this screen, the buyer may be able to provide additional details regarding the property (i.e., purchase offer price, deposit amount, comments, seller contact, and the like). The buyer may then be able to select “generate LOT,” or the like. After the letter of intent is generated, the buyer may have the option of uploading and sending the letter of intent to the seller of the selected property. Preferably, after the letter of intent is generated, it may be uploaded to the website. In this regard, the buyer may have a number of documents related to one or more transactions uploaded to the website. These documents may be stored within the website itself. The system and/or website may be configured to receive the letter of intent from the buyer. In other embodiments, the step of generating, in a computer or a mobile device, and receiving, in a computer or a mobile device, a letter of intent from the buyer is omitted.

### Task List and Calendar

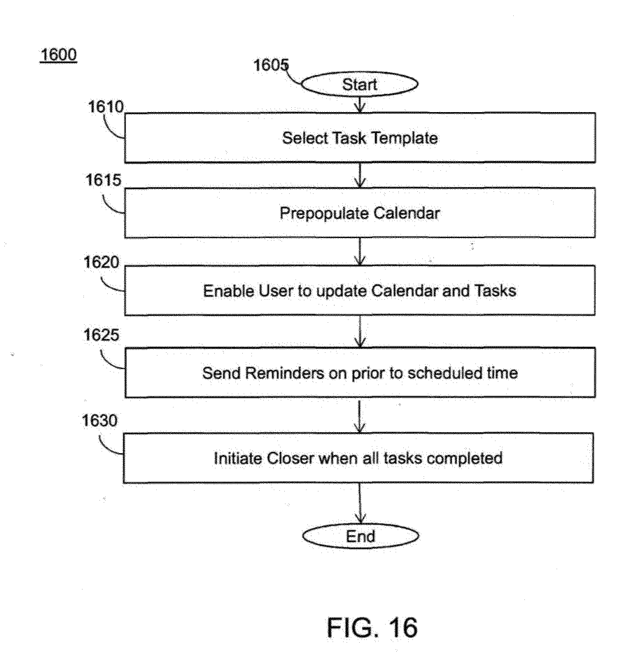

In some embodiments, and referring to FIG. 16, system 1140 of the present invention includes a calendar module 405, a task list module 410, and/or task list templates 415. Referring to FIG. 16, system 3140 may be configured to select task template 1610 (from, for example, task list template module 415), prepopulate calendar 1615 (with, for example, dates/time intervals associated with the specified task), enable user to update calendar and task list 1620 (with, for example, dates of completion), send reminders prior to scheduled time 1625 (i.e., electronic reminders to buyer or seller), and initiate closer when all tasks are completed 1630. Task list templates may be initiated/generated by system 1140 and/or by the buyer or seller. These templates may be used to populate the calendar. Examples of task list templates are building inspection, environmental inspection, and the like. It is to be understood that the task list templates may vary depending on the type of transaction.

Preferably, the task list is generated after sending the letter of intent to the seller. In some embodiments, the system and method of the present invention includes the step of providing, in a computer or a mobile device, an online calendar. Preferably, the task list displays items that may need to be done once an offer is made on a selected property. These items may include, but are not limited to, site visit, a financial audit, review of existing contracts and leases, environmental review, and various building inspections. The buyer may include dates that these tasks need to be completed. Upon clicking a button (i.e., the “display calendar” button within the webpage), the buyer may be able to view a calendar with the inputted dates. In some embodiments, the seller may be able to view the buyer's calendar. In other embodiments, the steps of providing, in a computer or a mobile device, a task list and/or calendar, is omitted.

### Buyer/Seller Transaction Management Tool

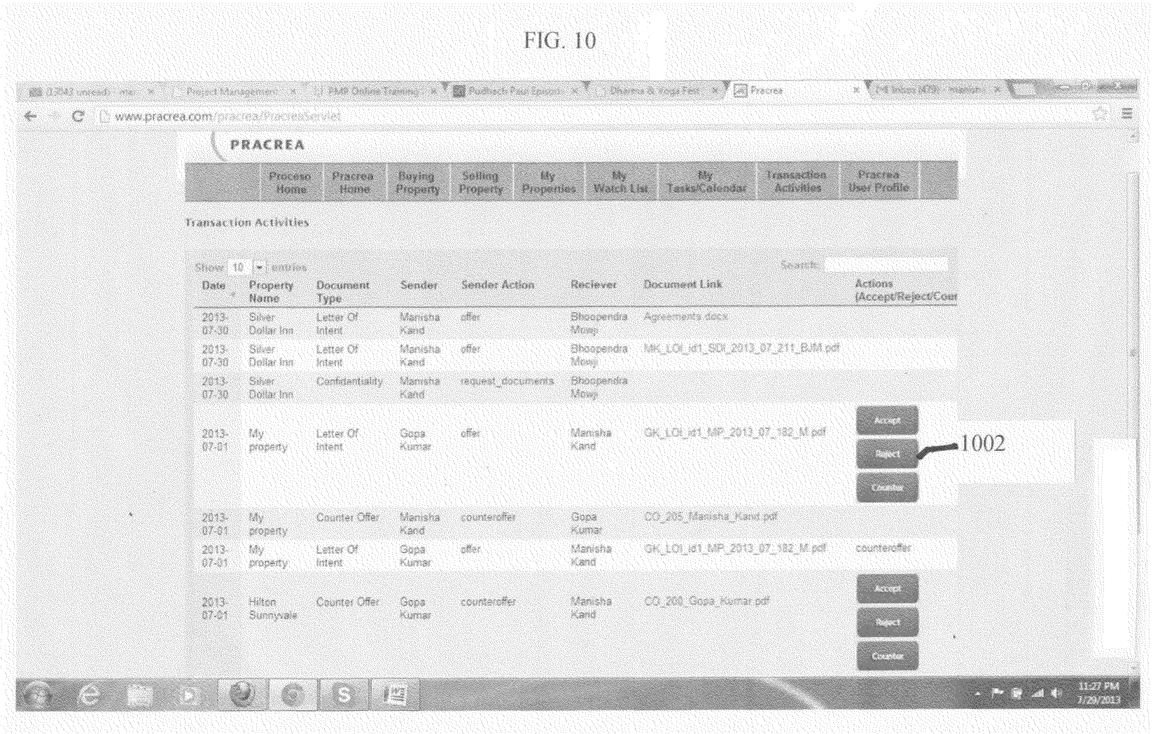

In some embodiments, and as shown in FIG. 12, the system and method of the present invention includes the step of providing, in a computer or a mobile device, a workflow module 1225. Workflow module 1225 may include a transaction management tool related to a particular real estate transaction, such as to a hotel sale/purchase. An exemplary transaction tool is shown in FIG. 10. Preferably, the transaction management tool is available for viewing online using communication module 1430. Preferably, the transaction management tool displays property name, document type, sender action, receiver, a link to the document, and an “action” tab (accept/reject/counteroffer—as discussed further below). In this regard, the buyer or the seller may easily view the events related to each real estate transaction they are a party to. The buyer and the seller can determine the status of each real estate transaction in an efficient and organized manner, as well as documents related to each real estate transaction—and all preferably online. In other embodiments, the step of providing, in a computer or a mobile device, the buyer and the seller with a transaction management tool related to a particular real estate transaction is omitted.

In some embodiments, the transaction management tool may include an option to accept, reject, or make a counteroffer (as shown in 1002). Preferably, this option is provided within the website itself. Referring to FIG. 10, for example, if the seller receives an offer, or a letter of intent, then the action (the letter of intent) is preferably viewable in the transaction management tool. Preferably, the seller is provided with a button or tab to “accept,” “reject,” or “counteroffer” adjacent to the action. In this manner, the system and/or website is configured to provide the seller with an offer, or letter of intent, online, as well as provide the seller with an option to “accept,” “reject,” “counteroffer” online and electronically within the website itself. If the seller selects “counteroffer” for example, then the seller may be able to provide a counteroffer. In this regard, in some embodiments, the system and method of the present invention includes the step of generating, in a computer or a mobile device, a counteroffer. Preferably, the counteroffer is in the form of a document that is generated after the seller (or the buyer) decides to make a counteroffer. Once the counteroffer is generated, it is preferably viewable in the transaction management tool of the buyer and/or seller. In this manner, the buyer and seller may go back and forth with for example, a sale price/purchase price of a particular property such as a hotel or a motel without actually leaving the website. Preferably, the flow stops if the offer is rejected. In this instance, the buyer can initiate another offer. The buyer and seller can go back and forth with offers/counteroffers until an offer or counteroffer is accepted or rejected. If the offer is accepted and/or both parties agree to its terms, then the flow stops, and the closing process, as discussed below, may be initiated. In other embodiments, the step of providing, in a computer or a mobile device, the buyer and the seller with an option to accept, reject, or make a counteroffer is omitted.

A workflow between a buyer and a seller may be completed using the transaction management tool of the present invention. For example, a sender, such as a buyer or seller, may initiate a document 1510. The sender may utilize an online template or form to provide information in order to populate the document 1515. Thereafter, the system may utilize the foregoing information provided by the seller to create and generate the document 1520. In some embodiments, an email notification may be sent to the receiver (i.e., a buyer or a seller), notifying the receiver of the document 1530. Referring to FIG. 12, workflow module 1225 may insert a row in the transaction management tool webpage in order to keep track of the interaction between buyer and seller. The receiver may receive an email notification 1535 regarding the existence of the document and may evaluate the document 1540. The receiver may decide to accept, reject, or counter 1545, and notification of the same may be sent to sender, along with updated documents (i.e., a counteroffer) 1550. At step 1555, the receiver has accepted, rejected, or countered the document. The foregoing interaction may be repeated. Preferably, each interaction adds a row to the transaction management tool webpage. In some embodiments, one or more of the foregoing steps may be omitted.

### Closing/Escrow Tool

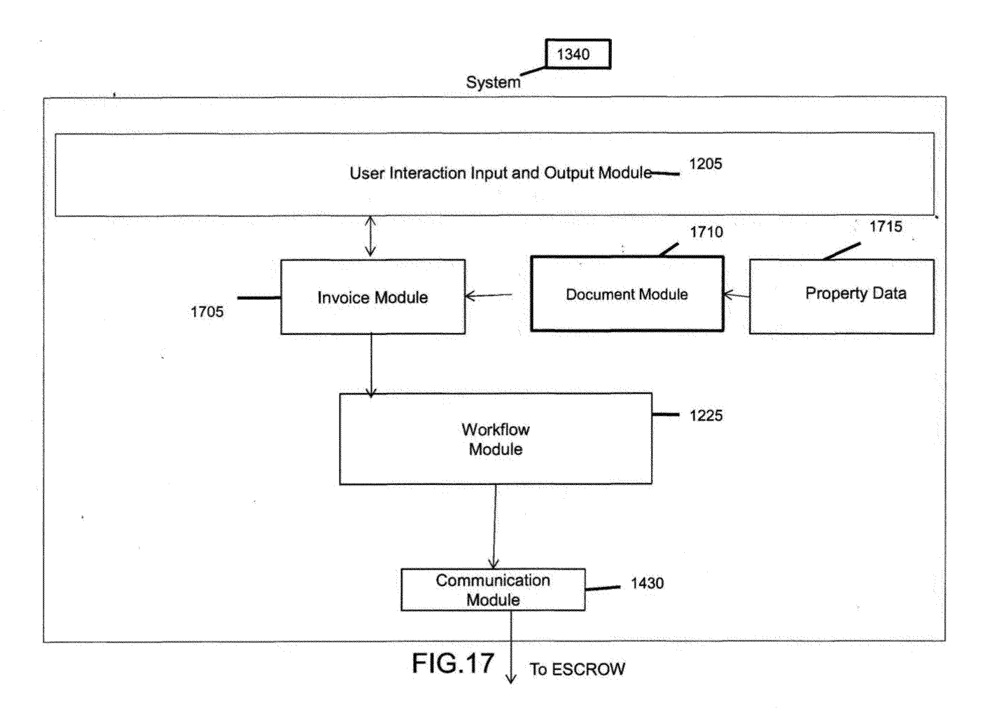

In some embodiments, and referring to FIGS. 17 and 18, system 1410 includes an invoice module 1705, document module 1710, and/or a property data module 1715 (referred to collectively as “closing/escrow tool”) to organize and gather data to be sent to an escrow agency. Referring to FIGS. 14 and 17, the closing/escrow tool may interact with workflow module 1225, buyer and seller document modules 1230 or 1235, and/or document generation modules 1410 and 1420, in order to accomplish this function. The closing/escrow tool may be fully automated to interact with an escrow agency and/or may be assisted by one or more individuals to accomplish this step. For example, once an purchase agreement and/or offer is accepted, the system and/or closing escrow tool may be triggered to evaluate the transaction, gather the documents and/or invoices related to the transaction that are necessary for the closing step, and electronically transmit the documents to the appropriate escrow agency. In other embodiments, the step of providing a closing/escrow tool or module is omitted.

For example, and referring to FIG. 18, system 1410 of the present invention may be configured to do one or more of the following: collect property data 1805 (i.e., property data from property data module 1715 to be used in during closing), generate invoice documents 1810 (i.e., invoices related to the agency's services), collect relevant property documents 1815 (i.e., documents related to the subject transaction and necessary for closing), generate an email 1820 having relevant documents, invoices, and property data, send email to escrow agency 1825 having the same, receive escrow payment 1830 (i.e., receipt of payment for agency's services through the escrow account), and/or mark property transaction closed 1835. In other embodiments, invoice module 1705, document module 1710, and/or property data module 1715 may be omitted.

In some embodiments, the present invention includes a system for providing online real estate transaction services to a seller and a buyer. Preferably, the system includes a memory and a processing circuit. The memory may include a server module stored on the memory, and configured to perform any combination of the steps described herein. For example, the server module may be configured to receive information from a seller regarding property to be sold and generate an online, automated valuation of the property based upon information provided by the seller. The system may include a network communication interface for providing connectivity to the server module and a client module.

In some embodiments, the present invention includes a system for providing online real estate transaction services to a seller and a buyer. Preferably, the system includes a memory and a processing circuit. The memory may include a client module stored on the memory, and configured to perform any combination of the steps described herein. The system may include a network communication interface for providing connectivity to the client module and a server module.

In some embodiments, the present invention includes a computer-readable program product comprising a non-transitory computer-readable storage medium comprising code for managing a commercial real estate transaction between a buyer and a seller from receiving information from the seller regarding a commercial property to be sold to closing. It is to be understood that the computer-readable program product comprising code for managing a commercial real estate transaction between a buyer and a seller may include a non-transitory computer-readable storage medium comprising code for any of the methods/steps described herein.

In some embodiments, the present invention includes a non-transitory computer-readable medium including computer executable instructions. The computer executable instructions may be adapted to perform any combination of steps described herein. For example, the computer executable instructions may be adapted to perform the steps of receiving, in a computer or a mobile device, information from the seller regarding a property to be sold and generating, in a computer or a mobile device, an online, automated valuation of the property based upon information provided by the seller.

One or more of the components, steps, features and/or functions illustrated in the FIGS. may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the FIGS. may be configured to perform one or more of the methods, features, or steps described in the FIGS. The novel algorithms described herein may also be efficiently implemented in software and/or embedded in hardware.

Also, it is noted that at least some implementations have been described as a process that is depicted as a flowchart, a flow diagram, a structure diagram, or a block diagram. Although a flowchart can describe the operations as a sequential process, many of the operations can be performed in parallel or concurrently. In addition, the order of the operations can be re-arranged. A process is terminated when its operations are completed. A process can correspond to a method, a function, a procedure, a subroutine, a subprogram, etc. When a process corresponds to a function, its termination corresponds to a return of the function to the calling function or the main function.

Moreover, embodiments can be implemented by hardware, software, firmware, middleware, microcode, or any combination thereof. When implemented in software, firmware, middleware or microcode, the program code or code segments to perform the necessary tasks can be stored in a machine-readable medium such as a storage medium or other storage(s). A processor can perform the necessary tasks. A code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted via any suitable means including memory sharing, message passing, token passing, network transmission, etc.

Furthermore, embodiments may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The terms “machine-readable medium”, “computer-readable medium”, and/or “processor-readable medium” can include, but are not limited to portable or fixed storage devices, optical storage devices, and various other non-transitory mediums capable of storing, containing or carrying instruction(s) and/or data. Thus, the various methods described herein can be partially or fully implemented by instructions and/or data that can be stored in a “machine-readable medium”, “computer-readable medium”, and/or “processor-readable medium” and executed by one or more processors, machines and/or devices.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein can be embodied directly in hardware, in a software module executable by a processor, or in a combination of both, in the form of processing unit, programming instructions, or other directions, and can be contained in a single device or distributed across multiple devices. A software module can reside in RAM memory, flash memory, ROM memory, EPROM memory, EEPROM memory, registers, hard disk, a removable disk, a CD-ROM, or any other form of storage medium known in the art. A storage medium can be coupled to the processor such that the processor can read information from, and write information to, the storage medium. In the alternative, the storage medium can be integral to the processor.

Those of skill in the art would further appreciate that the various illustrative logical blocks, modules, circuits, and algorithm steps described in connection with the embodiments disclosed herein can be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The various features of the invention described herein can be implemented in different systems without departing from the invention. It should be noted that the foregoing embodiments are merely examples and are not to be construed as limiting the invention. The description of the embodiments is intended to be illustrative, and not to limit the scope of the claims. As such, the present teachings can be readily applied to other types of apparatuses and many alternatives, modifications, and variations will be apparent to those skilled in the art.

What is claimed is:

1. A computer-readable program product comprising a non-transitory computer-readable medium comprising code for:
a. receiving and processing information from a first seller and a first buyer regarding purchase price and other values related to a first commercial real estate transaction;
b. populating a first offer or a first counteroffer document with the information;
c. generating the first offer or the first counteroffer document; and
d. providing the first offer or the first counteroffer document to the first buyer or the first seller;
e. providing the first seller or the first buyer the option to accept, reject, or counteroffer the first offer or the first counteroffer document;
f. sending notification to the first seller or the first buyer regarding acceptance, rejection, or counteroffer of the first offer document or the first counteroffer document;
g. displaying transaction history between the first buyer and the first seller related to the first commercial real estate transaction.

2. The computer-readable program product of claim 1, wherein the non-transitory computer-readable medium comprises code for:
a. retrieving standard industry data from third party sources; and
b. receiving and processing financial information and documents provided by the first seller to generate a valuation of a first commercial property.

3. The computer-readable program product of claim 2, wherein the non-transitory computer-readable medium comprises code for:
a. receiving information from the first buyer regarding a selected commercial property, wherein the selected commercial property is the first commercial property.

4. The computer-readable program product of claim 3, wherein the non-transitory computer-readable medium comprises code for:
a. estimating future financial data of the selected commercial property; and
b. providing the future financial data to the first buyer.

5. The computer-readable program product of claim 4, wherein the step of estimating future financial data of the selected commercial property includes the steps of:
a. determining a deviation of the selected commercial property from standard industry data in a given location; and
b. using the deviation to determine to determine financial data of the selected commercial property for subsequent years.

6. The computer-readable program product of claim 5, wherein future financial data comprises vacancy rate.

7. The computer-readable program product of claim 1, wherein the non-transitory computer-readable medium comprises code for:
a. displaying transaction history between the first seller and a second buyer related to a second commercial real estate transaction.

8. The computer-readable program product of claim 1, wherein the non-transitory computer-readable medium comprises code for:
a. displaying transaction history between the first buyer and a second seller related to a third commercial property transaction.

9. The computer-readable program product of claim 1, wherein the non-transitory computer-readable medium comprises code for:
a. populating a second offer document or a second counteroffer document with the information;
b. generating the second offer document or the second counteroffer document; and
c. providing the second offer document or the second counteroffer document to the first buyer or the first seller; and
d. providing the first seller or the first buyer the option to accept, reject, or counteroffer the second offer document or the second counteroffer document.

10. The computer-readable program product of claim 1, wherein the non-transitory computer-readable storage medium comprises code for providing the first buyer with an option to view financial information and documents related to the property.

11. A system for managing a commercial real estate transaction between a buyer and a seller comprising:
a. a memory;
b. a processing circuit; and
c. a server module stored on the memory;
wherein the system is configured to perform the steps of:
a. receiving and processing information from a first seller and a first buyer regarding purchase price and other values related to a first commercial real estate transaction;
b. populating a first offer document or first counteroffer document with the information;
c. generating the first offer document or the first counteroffer document; and
d. providing the first offer document or the first counteroffer document to the first buyer or the first seller;
e. providing the first seller or the first buyer the option to accept, reject, or counteroffer the first offer document or the first counteroffer document;
f. sending notification to the first seller or the first buyer regarding acceptance, rejection, or counteroffer of the first offer document or the first counteroffer document;
g. displaying transaction history between the first buyer and the first seller related to the first commercial real estate transaction.

12. The system of claim 11, wherein the system is configured to perform the steps of:
a. retrieving standard industry data from third party sources; and
b. receiving and processing financial information and documents provided by the first seller to generate a valuation of a first commercial property.

13. The system of claim 12, wherein the system is configured to perform the step of:
a. receiving information from the first buyer regarding a selected commercial property, wherein the selected commercial property is the first commercial property.

14. The system of claim 13, wherein the system is configured to perform the steps of:
a. estimating future financial data of the selected commercial property; and
b. providing the future financial data to the buyer.

15. The system of claim 14, wherein the system is configured to perform the steps of:
a. determining a deviation of the selected commercial property from standard industry data in a given location; and
b. using the deviation to determine to determine financial data of the selected commercial property for subsequent years.

16. A computer-implemented method for managing a commercial real estate transaction between a buyer and a seller comprising:
a. receiving and processing, in a computer or a mobile device, information from a first seller and a first buyer regarding purchase price and other values related to a first commercial real estate transaction;
b. populating, in a computer or a mobile device, a first offer document or a first counteroffer document with the information;
c. generating, in a computer or a mobile device, the first offer document or first counteroffer document;
d. providing, in a computer or a mobile device, the first offer document or the first counteroffer document to the first buyer or the first seller;
e. providing, in a computer or a mobile device, the first seller or the first buyer the option to accept, reject, or counteroffer the first offer document or the first counteroffer document;
f. sending, in a computer or a mobile device, notification to the first seller or the first buyer regarding acceptance, rejection, or counteroffer of the first offer document or the first counteroffer document; and
h. displaying, in a computer or a mobile device, transaction history between the first buyer and the first seller related to the first commercial real estate transaction.

17. The computer-implemented method of claim 16, further comprising the steps of:
a. retrieving standard industry data from third party sources; and
b. receiving and processing financial information and documents provided by the first seller to generate a valuation of a first commercial property.

18. The computer-implemented method of claim 17, further comprising the step of:
a. receiving information from the first buyer regarding a selected commercial property, wherein the selected commercial property is the first commercial property.

19. The computer-implemented method of claim 18, further comprising the step of:
a. estimating future financial data of the selected commercial property; and
b. providing the future financial data to the buyer.
